(19) United States
(12) Patent Application Publication
(10) Pub. No.: US 2019/0105967 A1
(43) Pub. Date: Apr. 11, 2019

(54) PRESSURE RELIEF VENT

(71) Applicant: Illinois Tool Works Inc., Glenview, IL (US)

(72) Inventors: Laurent Huet, Meru (FR); Jordan Michael Stevenson, Commerce, MI (US)

(73) Assignee: Illinois Tool Works Inc., Glenview, IL (US)

(21) Appl. No.: 16/139,306

(22) Filed: Sep. 24, 2018

Related U.S. Application Data
(60) Provisional application No. 62/568,589, filed on Oct. 5, 2017.

(51) Int. Cl. B60H 1/24; F16K 1/14; B60H 1/26

(52) U.S. Cl. CPC B60H 1/249; B60H 2001/003; B60H 1/26; F16K 1/14

(57) ABSTRACT

A pressure relief vent includes an enclosure and at least one blocking element. The enclosure defines an air flow channel through a thickness of the enclosure. The enclosure includes at least one guide member that defines a track oriented transverse to a depth axis through the thickness. The at least one blocking element is held within track and is translatable between a seated position and a displaced position. The at least one blocking element plugs the air flow channel when in the seated position, and the air flow channel is at least partially unobstructed when the at least one blocking element is in the displaced position. The at least one blocking element is configured to be moved from the seated position to the displaced position by positive air pressure on an interior side of the enclosure to permit outbound air flow through the air flow channel.

### CROSS-REFERENCE TO RELATED APPLICATIONS

This application claims the benefit of U.S. Provisional Application No. 62/568,589, titled “Flapless Pressure Relief Vent,” and filed Oct. 5, 2017, which is herein incorporated by reference in its entirety.

### BACKGROUND

Embodiments of the present disclosure generally relate to pressure-activated relief vents within ventilation systems, such as, but not limited to, vehicle ventilation systems.

Modern automobiles and other transportation vehicles have internal cabins that are insulated to reduce road noise and shield the vehicle occupants from outside weather (e.g., hot and cold temperatures, precipitation, etc.). The insulation may at least partially seal the internal cabin from the exterior environment, which can lead to a pressure differential between the internal cabin and the exterior environment. For example, the air pressure within the internal cabin may be greater than the external air pressure due to air conditioning (which may increase the internal air pressure), the vehicle traversing up a grade (which may reduce the external air pressure), or the like.

Some known vehicle ventilation systems have flap-based vents to reduce the pressure differential. For example, the known vents may have a hinged flap that pivots to an open position by a positive pressure acting against an interior side of the flap to relieve the excess pressure within the internal cabin by allowing the discharge of air from the internal cabin. Known flap-based vents have several associated issues. For example, the flap-based vents may permit an undesirable degree of noise transmission through the vent into the internal cabin. In addition, the hinged flaps may require significant positive air pressure before actuating from the closed position to the open position, which may obstruct air flow, slowing and/or delaying pressure equalization.

### SUMMARY

A need remains for a pressure relief vent which provides increased airflow therethrough at lower activation pressures than known flap-based vents while reducing noise transmission and blocking inbound air flow into the cabin.

With that need in mind, some embodiments of the present disclosure provide a pressure relief vent that includes an enclosure and at least one blocking element. The enclosure has a thickness extending along a depth axis from an interior side of the enclosure to an exterior side of the enclosure. The enclosure defines an air flow channel that extends through the thickness of the enclosure. The enclosure includes at least one guide member between the interior and exterior sides. The at least one guide member defines a track that is oriented transverse to the depth axis. The at least one blocking element is held within the track within the enclosure. The at least one blocking element is translatable along the track between a seated position and a displaced position. The at least one blocking element plugs the air flow channel when in the seated position, and the air flow channel is at least partially unobstructed when the at least one blocking element is in the displaced position. The at least one blocking element is configured to be moved from the seated position to the displaced position by positive air pressure on the interior side of the enclosure to permit outbound air flow through the air flow channel.

Some embodiments provide a pressure relief vent that includes an enclosure and at least one blocking element. The enclosure has a vertical height from a top end of the enclosure to a bottom end of the enclosure and has a thickness from an interior side of the enclosure to an exterior side of the enclosure. The enclosure defines an air flow channel that extends through the thickness of the enclosure. The enclosure includes at least one guide member defining a vertically-inclined track between the interior and exterior sides. The at least one blocking element is held by the enclosure and free-floating within the track. The at least one blocking element is translatable along the track between a seated position and a displaced position that is vertically higher than the seated position. The at least one blocking element plugs the air flow channel when in the seated position, and the air flow channel is at least partially unobstructed when the at least one blocking element is in the displaced position. The at least one blocking element is biased towards the seated position by the force of gravity and is configured to be lifted from the seated position to the displaced position by positive air pressure on the interior side of the enclosure to permit outbound air flow through the air flow channel.

Some embodiments provide a pressure relief vent that includes an enclosure and at least one blocking element. The enclosure has a thickness extending along a depth axis from an interior side of the enclosure to an exterior side of the enclosure and has a width extending along a lateral axis from a first side edge of the enclosure to a second side edge of the enclosure. The enclosure defines an air flow channel that extends through the thickness of the enclosure. The enclosure includes at least one guide member between the interior and exterior sides. The at least one guide member defines a track that is oriented transverse to the depth axis. The at least one blocking element is held within the track within the enclosure. The at least one blocking element is elongated parallel to the lateral axis of the enclosure. An outer surface of the at least one blocking element is at least one of slidable or rollable along the at least one guide member between a seated position and a displaced position. The outer surface of the at least one blocking element plugs the air flow channel when in the seated position, and the air flow channel is at least partially unobstructed when the at least one blocking element is in the displaced position. The at least one blocking element is configured to be moved from the seated position to the displaced position by positive air pressure on the interior side of the enclosure to permit outbound air flow through the air flow channel.

### BRIEF DESCRIPTION OF THE DRAWINGS

FIG. 1 is a perspective view of a pressure relief vent according to an embodiment of the present disclosure.

FIG. 2 is an exploded perspective view of the pressure relief vent shown in FIG. 1.

FIG. 3 is a back perspective view of a frame of the pressure relief vent shown in FIGS. 1 and 2.

FIG. 4 is a side perspective view of the frame of FIG. 3.

FIG. 5 is a perspective cross-sectional view of the pressure relief vent according to the embodiment shown in FIGS. 1 through 4.

FIG. 6 is a cross-sectional view of the pressure relief vent taken along line 6-6 in FIG. 5.

FIG. 7 is a cross-sectional view of the pressure relief vent taken along the line 6-6 showing blocking elements in a seated position relative to an enclosure.

FIG. 8 is another cross-sectional view of the pressure relief vent taken along the line 6-6 showing the blocking elements in the seated position.

FIG. 9 is an exploded perspective view of the enclosure of the pressure relief vent according to an alternative embodiment.

FIG. 10 is a perspective cross-sectional view of the pressure relief vent utilizing the enclosure shown in FIG. 9.

FIG. 11 is an exploded perspective view of the pressure relief vent according to an alternative embodiment.

FIG. 12 is a bottom perspective view of a cartridge of the pressure relief vent shown in FIG. 11.

FIG. 13 is a side perspective view of the pressure relief vent shown in FIGS. 11 and 12.

Before the embodiments of the disclosure are explained in detail, it is to be understood that the inventive subject matter is not limited in its application to the details and the arrangements of the components set forth in the following description or illustrated in the drawings. The disclosure is capable of other embodiments and of being practiced or being carried out in various ways. Also, it is understood that the phraseology and terminology used herein are for the purpose of description and should not be regarded as limiting. The use herein of terms such as “including” and “comprising” and variations thereof is meant to encompass the items listed thereafter and equivalents thereof, as well as additional items and equivalents thereof.

### DETAILED DESCRIPTION

One or more embodiments of the present disclosure are directed to a pressure relief vent that is configured to be mounted along a wall or panel of an enclosed space such that an interior side of the pressure relief vent is exposed to the enclosed volume and an opposite exterior side of the pressure relief vent is exposed to an external environment. For example, the pressure relief vent may be mounted along a wall of a room within a building such that the room represents the enclosed space. In another example, the pressure relief vent may be mounted along a panel of an internal cabin of a vehicle such that the internal cabin represents the enclosed space.

The pressure relief vent is configured to permit outbound air flow through the pressure relief vent to reduce the air pressure within the enclosed space relative to the air pressure outside of the enclosed space. For example, the pressure relief vent is activated from a closed position that blocks air flow to an open position that enables air flow based on a positive air pressure within the enclosed space. The positive air pressure within the enclosed space is indicative of a pressure differential across the pressure relief vent such that the pressure within the enclosed space is greater than the pressure outside of the enclosed space. The pressure relief vent is configured to remain in the open position until an equilibrium condition is achieved such that the pressure within the enclosed space is within a given range of the exterior pressure, and upon such event the pressure relief vent closes to restrict all air flow therethrough. According to one or more embodiments, the pressure relief vent is configured to block inbound air flow from the exterior environment into the enclosed space, even when the external pressure is greater than the pressure within the enclosed space. The pressure relief vent may restrict inbound air flow at all times to avoid the introduction of contaminants, debris, humidity, and the like from the exterior environment into the enclosed space.

The pressure relief vent according to one or more embodiments of the present disclosure incorporates at least one blocking element within an enclosure. Each blocking element may be free-floating and translatable via rolling and/or sliding along a respective track defined within the enclosure. The blocking element(s) may be biased towards a seated position that blocks air flow through the vent by the force of gravity or another biasing force. In response to a positive air pressure on the blocking element(s) along the interior side of the vent that is exposed to the enclosed space, the blocking element(s) may be temporarily displaced from the seated position to permit outbound air flow through the pressure relief vent until the positive pressure differential is relieved. The blocking element(s) return or resile towards the seated position once the positive pressure is achieved due to the biasing force to once again restrict air flow through the pressure relief vent.

The pressure relief vent according to the embodiments described herein may provide a number of benefits, such as quiet operation and low external noise transmission into the interior enclosed space. For example, the pressure relief vent may operate more quietly and may provide better noise insulation than known flap-based vents that sometimes flutter and clap. Another advantage of the pressure relief vent disclosed herein is that the activation pressure required to actuate the blocking element(s) is able to be tuned based on characteristics of the blocking element(s), such as weight. It is also noted that the pressure relief vent disclosed herein may be relatively easy to assemble and may be easily scalable to accommodate various space and air flow requirements. Additional details of the embodiments of the pressure relief vent are provided herein with reference to the accompanying drawings.

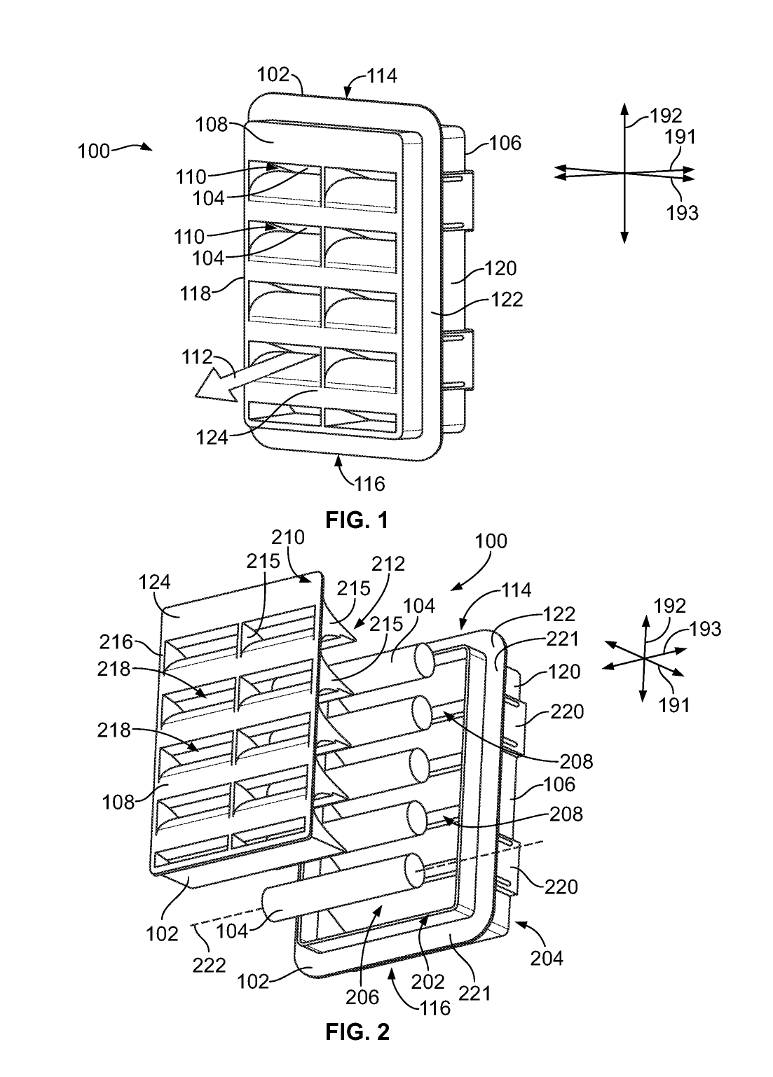

FIG. 1 is a perspective view of a pressure relief vent 100 according to an embodiment of the present disclosure. The pressure relief vent 100 includes an enclosure 102 and at least one blocking element 104 held within the enclosure 102. The enclosure 102 may be a frame, cage, or other such housing that contains the blocking element(s) 104 therein. The pressure relief vent 100 may include multiple blocking elements 104, as shown more clearly in FIG. 2. The enclosure 102 has an interior side 106 and an exterior side 108 that is opposite the interior side 106. The enclosure 102 is configured to be installed along a dividing structure that defines a portion of an enclosed space, such as a room or an internal cabin of a vehicle (e.g., an automobile or other road-based vehicle, a rail vehicle, a boat, or the like). The dividing structure may be a wall, a panel, a case, or the like. When installed, the interior side 106 of the enclosure 102 faces towards the enclosed space and is fluidly connected to the enclosed space. For example, the air within the enclosed space impinges upon the interior side 106 of the enclosure 102. The exterior side 108 faces away from the enclosed space towards the environment outside of the enclosed space. As used herein, relative or spatial terms such as “front,” “rear,” “top,” “bottom,” “interior,” and “exterior” are only used to identify and distinguish the referenced elements in the orientations shown in the figures and do not necessarily require particular positions or orientations relative to gravity and/or relative to the surrounding environment of the pressure relief vent 100.

The pressure relief vent 100 defines one or more air flow channels 110 through the enclosure 102 between the interior and exterior sides 106, 108. The pressure relief vent 100 permits outbound air flow through the one or more air flow channels 110. The outbound air flows from the enclosed space in an outbound direction 112 towards the external environment such that the air enters the one or more air flow channels 110 through the interior side 106 of the enclosure 102 and is discharged from the pressure relief vent 100 through the exterior side 108 of the enclosure 102. In at least one embodiment, the pressure relief vent 100 blocks inbound air flow through the one or more air flow channels 110. For example, air and other gases from the external environment are not permitted to flow through the pressure relief vent 100 into the enclosed space.

The pressure relief vent 100 is oriented with respect to a depth axis 191, a vertical axis 192, and a lateral axis 193. The axes 191-193 are mutually perpendicular. Although the vertical axis 192 appears to extend in a vertical direction parallel to the force of gravity in FIG. 1, it is understood that the axes 191-193 are not required to have any particular orientation with respect to gravitational force. The enclosure 102 has a thickness along the depth axis 191 from the interior side 106 to the exterior side 108. The one or more air flow channels 110 extend through the thickness of the enclosure 102 between the interior and exterior sides 106, 108 to provide a flow path that fluidly connects the enclosed spaced to the external environment.

The enclosure 102 has a height along the vertical axis 192 between a top end 114 and a bottom end 116 of the enclosure 102. The enclosure 102 has a width along the lateral axis 193 between a first side edge 118 and a second side edge 120 of the enclosure 102. In the illustrated embodiment, the enclosure 102 is an assembly that includes a housing 122 and a frame 124. The frame 124 is coupled to the housing 122. The blocking elements 104 are held between the housing 122 and the frame 124. The frame 124 defines at least a portion of the exterior side 108 of the enclosure 102.

FIG. 2 is an exploded perspective view of the pressure relief vent 100 shown in FIG. 1. The housing 122 of the enclosure 102 has a front end 202 and a back end 204 opposite the front end 202. The back end 204 defines the interior side 106 of the enclosure 102. The housing 122 defines a cavity 206 that is open along the front end 202. The frame 124 of the enclosure 102 couples to the front end 202 of the housing 122 to enclose the cavity 206. When the pressure relief vent 100 is assembled, the blocking elements 104 are sandwiched between the frame 124 and the housing 122 within the cavity 206. The housing 122 defines inlet openings 208 that fluidly connect the cavity 206 to the enclosed space beyond the interior side 106. The inlet openings 208 form segments of the air flow channels 110 (shown in FIG. 1) through the enclosure 102.

The frame 124 has a front end 210 and a back end 212 opposite the front end 210. The front end 210 defines the exterior side 108 of the enclosure 102. The frame 124 includes a face grate 216 at the front end 210 and multiple fins 215 that extend from the face grate 216 toward the back end 212. The fins 215 extend into the cavity 206 of the housing 122 and engage the blocking elements 104. The frame 124 defines multiple outlet openings 218 that fluidly connect the cavity 206 of the enclosure 102 to the external environment beyond the exterior side 108. The outlet openings 218 form segments of the air flow channels 110 (shown in FIG. 1) through the enclosure 102. Each of the air flow channels 110 includes a corresponding one of the inlet openings 208 of the housing 122, one of the outlet openings 218 of the frame 124 that aligns with the inlet opening 208, and intervening open space within the cavity 206 between the inlet opening 208 and the outlet opening 218. Air that flows through the pressure relief vent 100 is received in the enclosure 102 from the interior side 106 through the inlet openings 208, flows across the cavity 206 and is discharged through the outlet openings 218 along the exterior side 108.

The housing 122 may include mounting features 220 along a perimeter of the housing 122 for mounting the pressure relief vent 100 to a wall, panel, or other support structure. The housing 122 has two visible mounting features 220 along the second side edge 120, but any suitable number of mounting features may be utilized. The mounting features 220 may be configured to receive fasteners, or may include a clamp, clip, latch, or other retention mechanism. The housing 122 optionally also includes a flange 221 that extends around a perimeter of the housing 122. The flange 221 may be placed in contact with the support structure to ensure proper orientation of the enclosure 102 when mounting and/or proper sealing between the enclosure 102 and the support structure.

In the illustrated embodiment, each of the blocking elements 104 is elongated along a respective longitudinal axis 222. The blocking elements 104 are cylindrical in FIG. 2, but may have different elongated shapes in alternative embodiments. The blocking elements 104 may all have the same sizes, shapes, and compositions or may have sizes, shapes, and/or compositions that are different. The blocking elements 104 may be solid or hollow. In a non-limiting example embodiment, the blocking elements 104 may be hollow injection-molded rollers having a thermoplastic elastomer (TPE) composition or a foam polymer composition. For example, the blocking elements 104 may be solid or hollow rollers of foamed polyurethane or a similar polymer.

The blocking elements 104 may be arranged side-by-side in a line or stack. In the illustrated embodiment, the blocking elements 104 are vertically stacked parallel to the vertical axis 192 between the top and bottom ends 114, 116 of the enclosure 102. The blocking elements 104 in FIG. 2 are oriented parallel to one another and parallel to the lateral axis 193 (e.g., the longitudinal axis 222 is parallel to the lateral axis 193). When the pressure relief vent 100 is assembled, the blocking elements 104 may be generally retained in the illustrated orientation and arrangement, although the blocking elements 104 are movable within the cavity 206, as described herein.

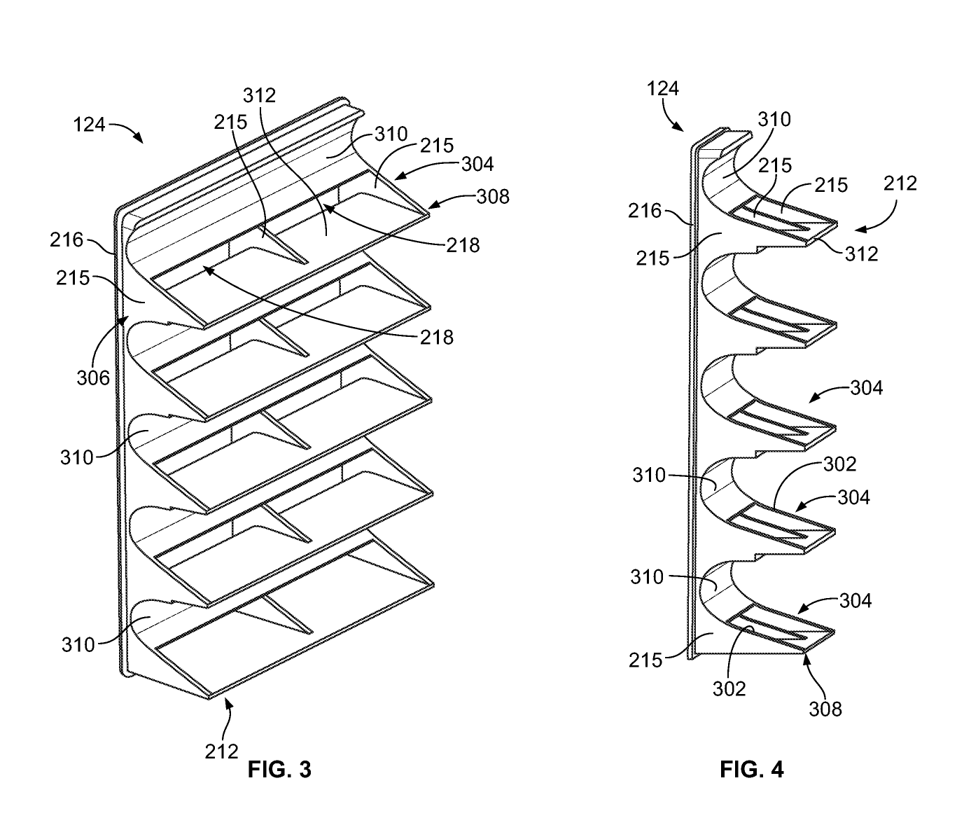

FIG. 3 is a back perspective view of the frame 124 of the pressure relief vent 100 shown in FIGS. 1 and 2. FIG. 4 is a perspective view of the frame 124 of FIG. 3. The fins 215 have sloped support surfaces 302 that engage the blocking elements 104 (shown in FIG. 2). The sloped support surfaces 302 define ramps 304. The blocking elements 104 are configured to roll and/or slide along the ramps 304.

In the illustrated embodiment, the fins 215 are spaced apart along at least a portion of a lateral width of the frame 124. The outlet openings 218 are located between the fins 215. For example, in the illustrated embodiment, each ramp 304 is defined by the sloped support surfaces 302 of three fins 215 aligned in a row 306. The three fins 314 in each row 306 are connected by a cross plate 312 that extends toward the back end 212 of the frame 124. The outlet openings 218 are located in the two areas between the three fins 215. The frame 124 includes multiple ramps 304 that are vertically stacked above one another. For example, the frame 124 has five ramps 304 in the illustrated embodiment, which corresponds to the five blocking elements 104 shown in FIG. 2. The frame 124 may have a different number of ramps 304 in other embodiments.

Each of the fins 215 of the frame 124 tapers from the face grate 216 to a respective distal end 308 at the back end 212 of the frame 124. The ramps 304 extend frontward from the distal ends 308 of the fins 215 to a respective a cradle surface 310. The cradle surfaces 310 have a concave curve and generally face towards the housing 122 (shown in FIG. 2). The cradle surfaces 310 define hard stop surfaces that limit the movement of the blocking elements 104 (shown in FIG. 2) and prevent the blocking elements 104 from exiting the cavity 206 (FIG. 2) through the frame 124.

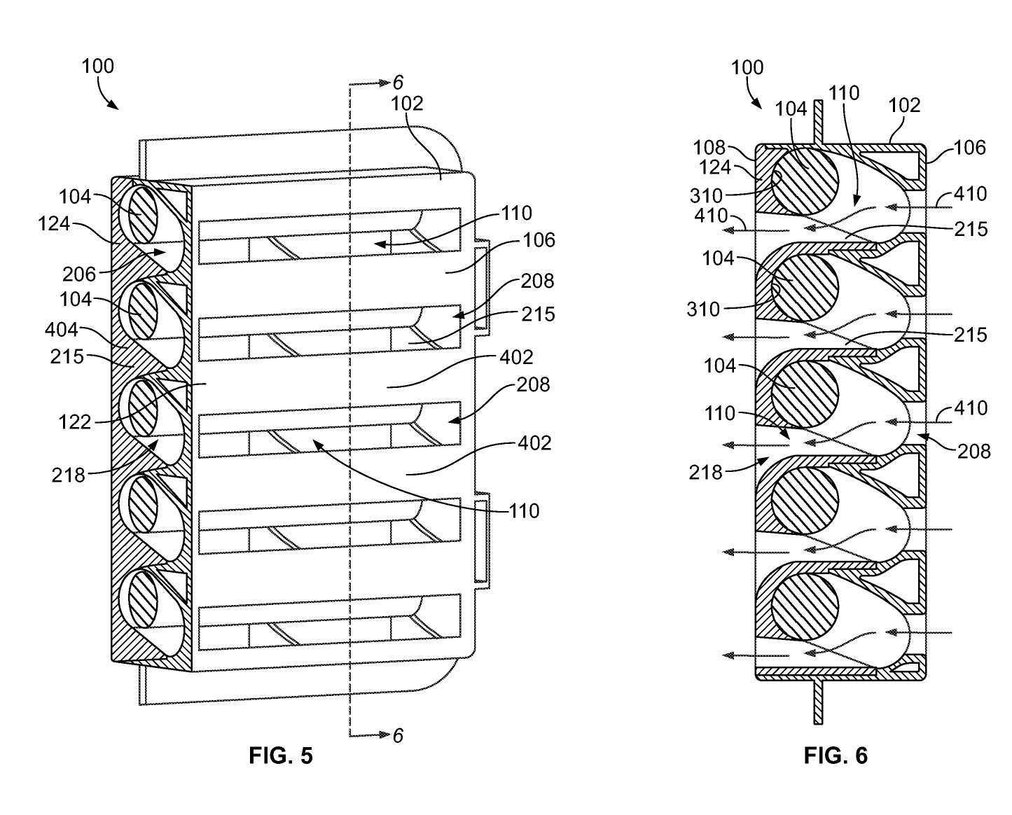

FIG. 5 is a perspective cross-sectional view of the pressure relief vent 100 according to the embodiment shown in FIGS. 1 through 4. FIG. 5 shows the interior side 106 of the enclosure 102. The inlet openings 208 of the housing 122 have rectangular shapes that are elongated along a lateral width of the housing 122, but other shapes of the inlet openings 208 are contemplated. The inlet openings 208 are vertically spaced apart from one another by cross beams 402 of the housing 122. As shown in FIG. 5, the blocking elements 104 are held within the cavity 206 of the housing 122. The blocking elements 104 are supported on corresponding guide members 404 of the enclosure 102, wherein the guide members 404 include the fins 215 of the frame 124. The blocking elements 104 are oriented parallel to a plane of the interior side 106 of the enclosure 102.

According to at least one embodiment, the blocking elements 104 are translatable within the cavity 206 between a seated position and a displaced position. Each blocking element 104 plugs a corresponding air flow channel 110 through the enclosure 102 when in the seated position and does not plug the air flow channel 110 when in the displaced position. When the blocking elements 104 are in the displaced positions, as seen in FIG. 5, the air flow channels 110 are at least partially unobstructed, which enables air flow through the pressure relief vent 100. Each of the air flow channels 110 includes a corresponding one of the inlet openings 208 of the housing 122, one of the outlet openings 218 of the frame 124 that aligns with the inlet opening 208, and intervening open space within the cavity 206 between the inlet opening 208 and the outlet opening 218.

FIG. 6 is a cross-sectional view of the pressure relief vent 100 taken along the line 6-6 in FIG. 5. The perspective of the cross-sectional view is along the lateral axis 193 (shown in FIG. 1), so the cylindrical blocking elements 104 shown in FIGS. 2 and 5 are illustrated as circular cross-sections in FIG. 6. Similar to FIG. 5, each of the blocking elements 104 is in the displaced position. In the displaced position, the blocking elements 104 may abut against corresponding cradle surfaces 310 of the frame 124.

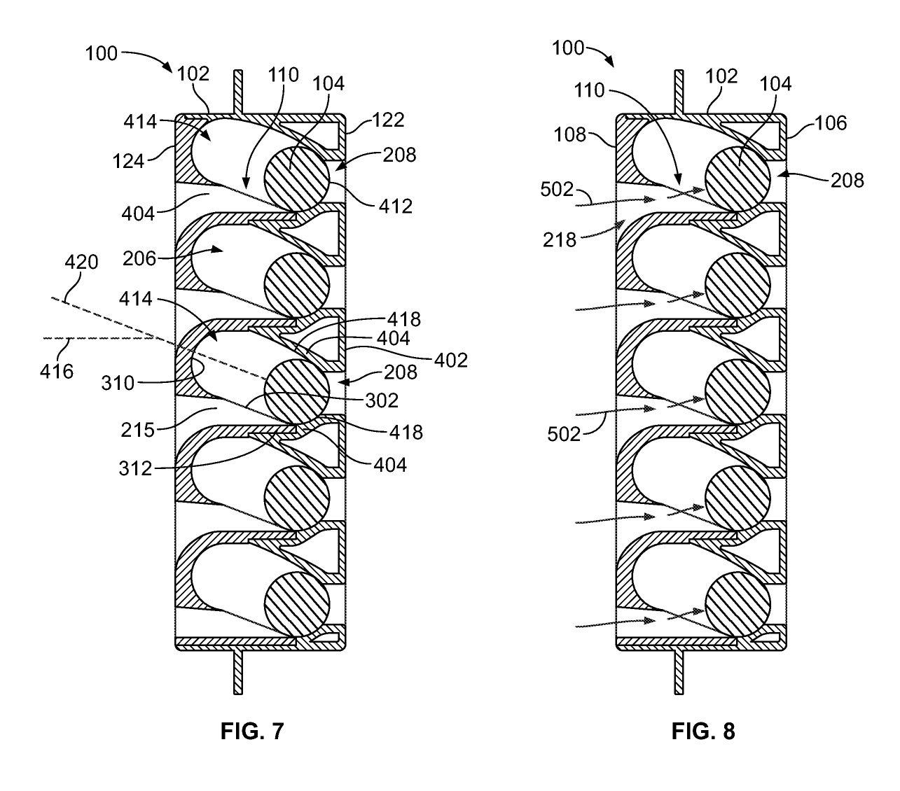

According to one or more embodiments, the blocking elements 104 may be translatable to the displaced positions based on a pressure differential across the thickness of the pressure relief vent 100. For example, if the air pressure along the interior side 106 of the enclosure 102 is greater than the air pressure along the exterior side 108, then a positive air pressure exists on the interior side 106. The positive air pressure may force the blocking elements 104 to move from the seated position (shown in FIGS. 7 and 8) to the displaced position to permit outbound air flow 410 through the air flow channels 110. For example, air from within the enclosed space enters the pressure relief vent 100 through the inlet openings 208. The air flows along the air flow channels 110 around the blocking elements 104 before being discharged from the pressure relief vent 100 through the outlet openings 218. FIG. 6 shows that the outbound air flow passes in front of the visible fins 215 of the frame 124 (e.g., between the fins 215 and the reader) because the fins 215 are set back from the cross-section line 6-6. The outbound air flow reduces the pressure differential by reducing the air pressure within the enclosed space.

FIG. 7 is a cross-sectional view of the pressure relief vent 100 taken along the line 6-6 showing each of the blocking elements 104 in the seated position relative to the enclosure 102. In the seated position, the blocking elements 104 plug the corresponding air flow channels 110, which blocks air flow through the pressure relief vent 100. For example, both outbound air flow and inbound air flow through the pressure relief vent 100 are restricted. The blocking elements 104 are disposed within the air flow channels 110 downstream (e.g., in the outbound flow direction) of a structure defining an aperture along the air flow channel 110. In the seated position, each blocking element 104 abuts against the structure and plugs the aperture. In the displaced position, the blocking elements 104 are spaced apart from the structure and do not plug the aperture. In the illustrated embodiment, the apertures of the air flow channels 110 are the inlet openings 208 of the housing 122. The blocking elements 104 have cross-sectional dimensions that are greater than dimensions of the inlet openings 208. For example, the diameter of the cylindrical blocking elements 104 in FIG. 7 is greater than a height of the inlet openings 208. As a result, outer surfaces 412 of the blocking elements 104 fully obstruct and cover the inlet openings 208.

The enclosure 102 includes one or more tracks 414 between the interior and exterior sides 106, 108. Each of the blocking elements 104 is held within a different track 414 and is translatable (e.g., able to physically move to a different location) along the track 414 between the seated position and the displaced position. The tracks 414 are defined by the guide members 404 of the enclosure 102. The blocking elements 104 translate by rolling and/or sliding along the guide members 404. In the illustrated embodiment, the guide members 404 of the enclosure 102 include features of both the frame 124 and the housing 122. For example, the sloped support surfaces 302 of the fins 215 of the frame 124 represent a segment of the track 414 and the cradle surfaces 310 of the frame 124 represent a first end of the track 414. The housing 122 includes shelves or ledges 418 that project forward into the cavity 206 from the cross beams 402 of the housing 122. The shelves 418 represent guide members 404 that also define segments of the tracks 414. In the illustrated embodiment, the shelves 418 engage the cross plates 312 of the frame 124. For example, the cross plates 312 may overlap the shelves 418 and abut against an upper surface of the shelves 418. The shelves 418 may taper from the cross beams 402 towards the frame 124. A second end of the track 414 opposite the first end is defined by two adjacent shelves 418 at a respective inlet opening 208.

In at least one embodiment, the tracks 414 are vertically inclined. For example, the tracks 414 are oriented transverse to the depth axis 191 (shown in FIGS. 1 and 2) of the enclosure 102. The tracks 414 in FIG. 7 are oriented along a track axis 420 that forms an acute angle with a horizontal line 416 parallel to the depth axis 191. Due to the incline of the tracks 414, the blocking elements 104 at the displaced position (at or proximate to the cradle surface 310) is at a greater height than at the seated position (at the inlet opening 208).

FIG. 7 shows the pressure relief vent 100 in a stable or equilibrium state, such that there is little if any pressure differential across the vent 100. In an embodiment, the blocking elements 104 are biased towards the seated position. The positive air pressure along the interior side 106 (shown by the arrows 410 in FIG. 6) exerts a force on the blocking elements 104 that exceeds the biasing force, causing the translation of the blocking elements 104 from the seated position to the displaced position. Without the positive air pressure from the interior side 106, the blocking elements 104 resile (e.g., return) to the seated position due to the biasing force. The blocking elements 104 move within the tracks 414 by sliding and/or rolling along the guide members 404. For example, the blocking elements 104 engage and ride along the shelves 418 of the housing 122 and the sloped support surfaces 302 of the fins 215 as the blocking elements 104 move between the displaced and seated positions.

In the illustrated embodiment, the blocking elements 104 are free-floating within the tracks 414 and the biasing force on the blocking elements 104 is the force of gravity (e.g., gravitational force). The weight of the blocking elements 104 and the incline or slope of the tracks 414 causes the blocking elements 104 to roll and/or slide towards the seated position. The outbound air flow temporarily lifts the blocking elements 104 to a greater elevation or height within the tracks 414 to achieve the displaced position until the pressure differential is reduced and an equilibrium state is attained. Upon attaining the equilibrium state, the blocking elements 104 roll and/or slide back down to the seated position. The slope of the tracks 414 and/or the weight of the blocking elements 104 may be selected to control the activation point of the pressure relief vent 100. The activation points refers to the amount of outbound air pressure (relative to the inbound air pressure) necessary to lift the blocking elements 104 to the displaced position and enable outbound air flow through the pressure relief vent 100.

FIG. 8 is another cross-sectional view of the pressure relief vent 100 taken along the line 6-6 showing the blocking elements 104 in the seated position. In FIG. 8, there is a pressure differential across the pressure relief vent 100 such that the air pressure along the exterior side 108 of the enclosure 102 is greater than the air pressure along the interior side 106. This condition is referred to as having a positive air pressure on the exterior side 108 of the enclosure 102. Inbound air, illustrated by arrows 502, enters the air flow channels 110 through the outlet openings 218. The inbound air flow through the air flow channels 110 is impeded by the blocking elements 104 which plug the inlet openings 208. Instead of displacing the blocking elements 104 from the seated position, the force exerted by the inbound air on the blocking elements 104 merely pushes the blocking elements 104 further towards the seated position. The inbound air flow is restricted from passing through the pressure relief vent 100 beyond the interior side 106 into the enclosed space. Therefore, no contaminants, debris, humidity, or the like, is allowed to enter the enclosed space through the pressure relief vent 100.

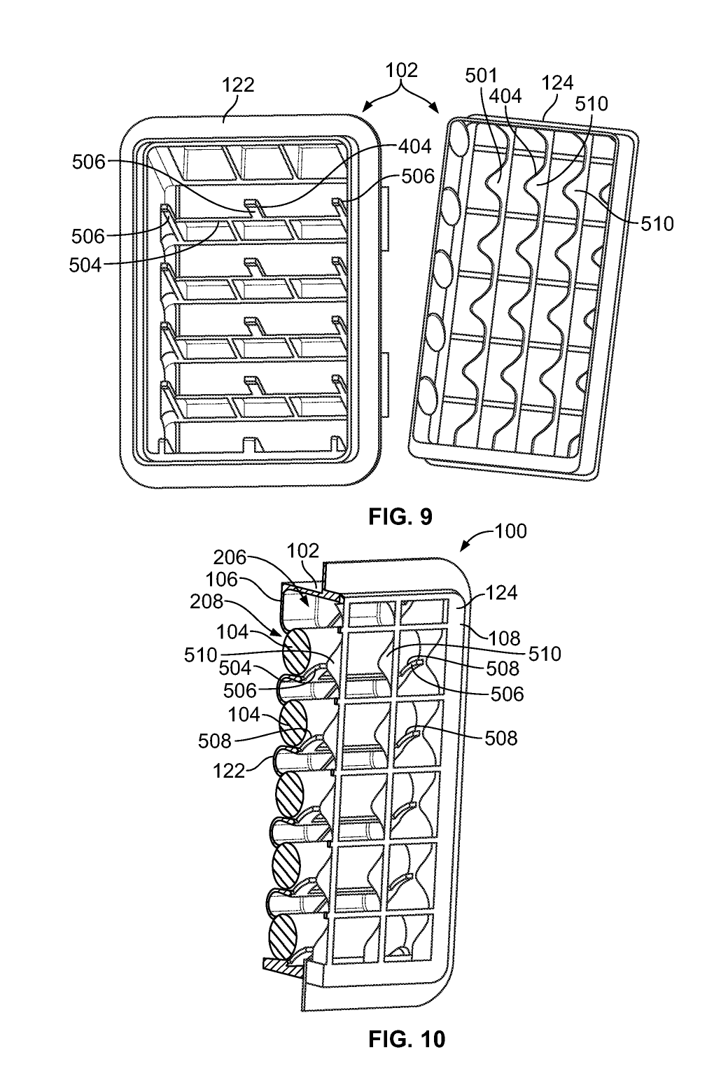

FIG. 9 is an exploded perspective view of the enclosure 102 of the pressure relief vent 100 according to an alternative embodiment. FIG. 10 is a perspective cross-sectional view of the pressure relief vent 100 utilizing the enclosure 102 shown in FIG. 9. The enclosure 102 includes the housing 122 and the frame 124. The housing 122 and the frame 124 in the illustrated embodiment may be more open than the embodiment shown in FIGS. 1 through 8, such that there is more open space within the cavity 206 of the enclosure 102 between the interior and exterior sides 106, 108.

The additional open space may be attributable to different guide members 404 that guide the movement of the blocking elements 104 between the seated and displaced positions. For example, the housing 122 in FIGS. 9 and 10 has relatively short shelves 504 and multiple beams 506 projecting from each of the shelves 504. The beams 506 are spaced apart along a width of the housing 122, similar to the spacing between the fins 215 of the frame 124 shown in FIG. 3. The beams 506 define sloped support surfaces 508 that engage and guide the blocking elements 104 as the blocking elements 104 roll and/or slide between the seated and displaced positions. The frame 124 includes multiple fins 510 that also represent guide members 404. The fins 510 in the illustrated embodiment are shorted and stubbier than the elongated fins 215 shown in FIG. 3. Furthermore, the fins 510 are not connected by cross plates.

Besides the noted variations in guide members 404 of the enclosure 102, the pressure relief vent 100 in FIGS. 9 and 10 operates the same way as the pressure relief vent 100 in FIGS. 1 through 8. For example, the blocking elements 104 are in the seated position in FIG. 10, such that the blocking elements 104 plug the inlet openings 208 and restrict air flow through the pressure relief vent 100. Positive air pressure along the interior side 106 may push the blocking elements 104 to move along the beams 506 and then along the fins 510 to the displaced position to enable outbound air flow.

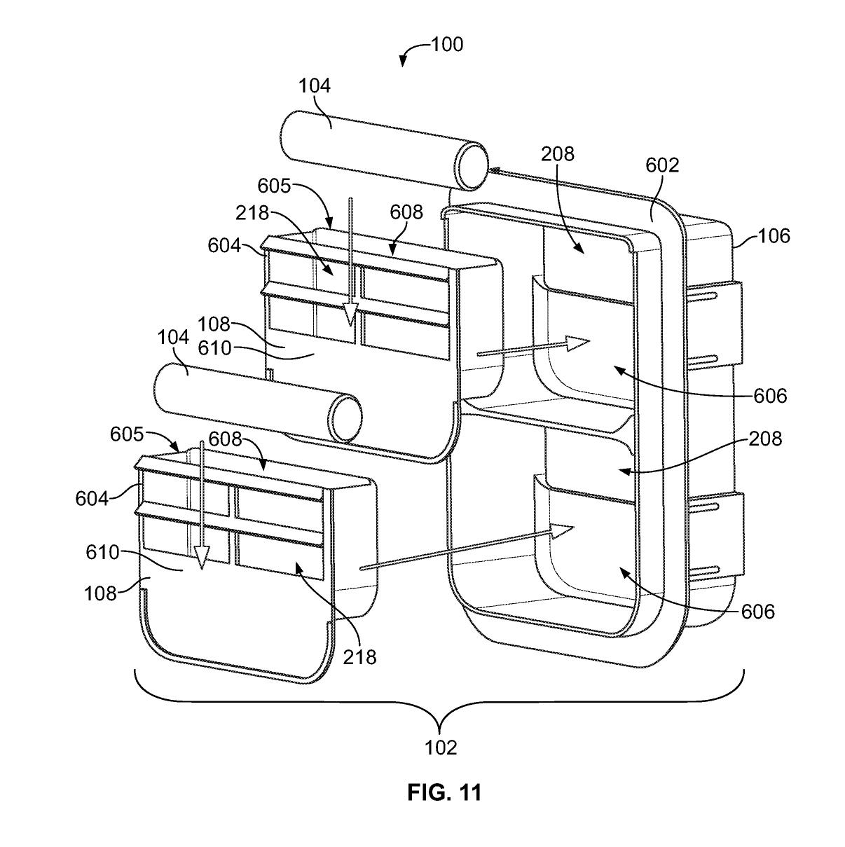

FIG. 11 is an exploded perspective view of the pressure relief vent 100 according to an alternative embodiment. The enclosure 102 in FIG. 11 includes a housing 602 and two cartridges 604 that are configured to couple to the housing 602. Each of the cartridges 604 defines at least a portion of the exterior side 108 of the enclosure 102. The enclosure 102 may have only one cartridge 604 or at least three cartridges 604 in alternative embodiments. The housing 602 defines individual cavities 606 to receive each of the cartridges 604. Each cavity 606 is fluidly connected to the enclosed space along the interior side 106 of the enclosure 102 by at least one corresponding inlet opening 208.

The cartridges 604 are hollow and have open top ends 605. The cartridges 604 define respective channels 608 that receive the blocking elements 104 through the open top ends 605. A single blocking element 104 is loaded into each of the cartridges 604 before inserting the cartridges 604 into the corresponding cavities 606 of the housing 602 to assemble the pressure relief vent 100. The cartridges 604 have front walls 610 along the exterior side 108. The channels 608 are fluidly connected to the exterior environment via outlet openings 218 defined through the front walls 610.

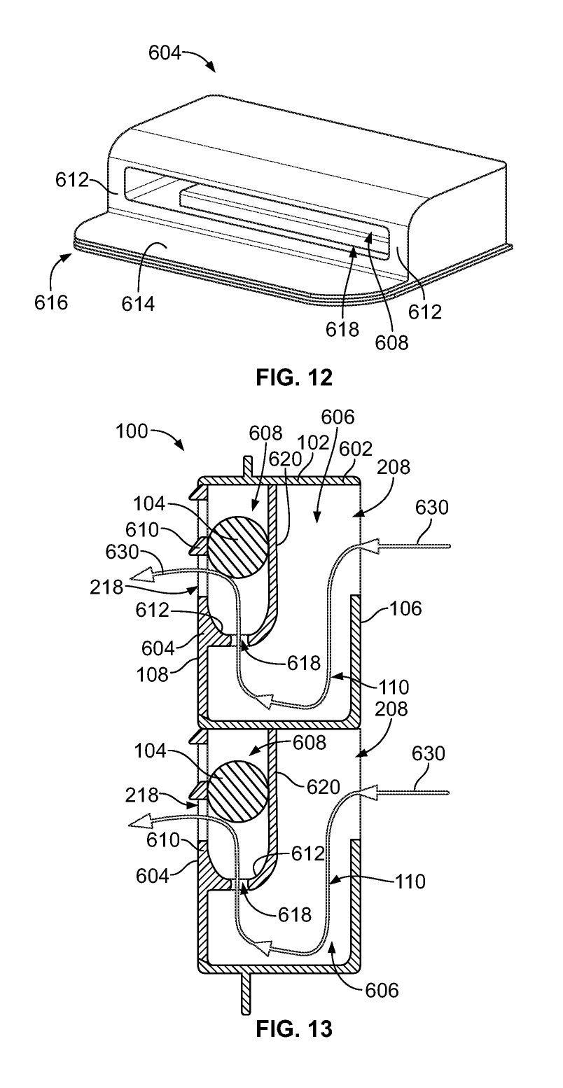

FIG. 12 is a bottom perspective view of one of the cartridges 604 of the pressure relief vent 100 shown in FIG. 11. The cartridge 604 includes a bottom wall 612 that defines a bottom of the channel 608. The cartridge 604 optionally includes a panel 614 extending beyond the bottom wall 612 to a bottom end 616 of the cartridge 604. The panel 614 interfaces with the housing 602 when assembled to enclose the cavity 606. The cartridge 604 defines an aperture 618 through the bottom wall 612. The aperture 618 allows air flow between the channel 608 and the cavity 606 of the housing 602.

FIG. 13 is a side perspective view of the pressure relief vent 100 shown in FIGS. 11 and 12. When the pressure relief vent 100 is assembled, the blocking elements 104 are housed within the channels 608 of the corresponding cartridges 604 within the corresponding cavities 606 of the housing 602. The enclosure 102 defines multiple air flow channels 110 through the enclosure 102. Each air flow channel 110 includes the inlet opening 208 along the interior side 106, open space within the cavity 606, the aperture 618 in the bottom wall 612 of the cartridge 604, the channel 608 of the cartridge 604, and the outlet openings 218 along the exterior side 108.

In the illustrated embodiment, the channel 608 is vertically oriented and is defined between the front wall 610 and a back wall 620 of the cartridge 604. The blocking element 104 is translatable within the channel 608 between the seated position and the displaced position. The blocking elements 104 are shown in the displaced position. In the seated position, the blocking elements 104 abut against and sit on top of the corresponding bottom walls 612 and cover the apertures 618. The front and back walls 610, 620 represent guide members that guide the movement of the blocking elements 104. In the displaced position shown, the blocking elements 104 are lifted away from the bottom walls 612 and do not obstruct, cover, or plug the apertures 618. For example, when there is positive air pressure along the interior side 106, outbound air flow (represented by arrows 630) from the enclosed space enters the cavities 606 through the inlet openings 208 and is routed around the back walls 620 of the cartridges 604. The air enters the apertures 618 and physically lifts the blocking elements 104 upward off of the bottom walls 612 to the displaced positions. The blocking elements 104 may be suspended in air by the force exerted on the blocking elements 104 by the outbound air flow. After entering the channel 608, the outbound air exits through the one or more outlet openings 218 into the exterior environment.

The flow of outbound air through the pressure relief vent 100 reduces the pressure differential across the pressure relief vent 100. Once an equilibrium condition is achieved, the weight of the blocking elements 104 (based on the force of gravity) causes the blocking elements 104 to drop back to the seated position on the bottom walls 612. Inbound air flow is restricted because the force exerted by the inbound air merely forces the blocking elements 104 further into the bottom walls 612 without dislodging the blocking elements 104 from the seated position.

Although the embodiments described herein show cylindrical blocking elements 104 having circular cross-sections, it is understood that the blocking elements 104 may have other shapes in other embodiments. For example, the blocking elements 104 may have elongated prism shapes that include at least one flat surface. The blocking elements 104 may have oblong or rectangular cross-sections. As a result of the oblong or rectangular cross-sections, the blocking elements 104 may only slide along the guide surfaces between the seated and displaced positions instead of both rolling and sliding.

Furthermore, although various embodiments described herein show free-floating blocking elements 104 that are biased towards the seated, air flow restricting positions via the force of gravity, it is understood that other biasing mechanisms may be used instead of or in addition to relying on the force of gravity. For example, spring elements may be installed to exert a biasing spring force on the blocking elements towards the seated position.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. Dimensions, types of materials, orientations of the various components, and the number and positions of the various components described herein are intended to define parameters of certain embodiments, and are by no means limiting and are merely example embodiments. Many other embodiments and modifications within the spirit and scope of the claims will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A pressure relief vent comprising:
an enclosure having a thickness extending along a depth axis from an interior side of the enclosure to an exterior side of the enclosure, the enclosure defining an air flow channel that extends through the thickness of the enclosure, wherein the enclosure includes at least one guide member between the interior and exterior sides, the at least one guide member defining a track that is oriented transverse to the depth axis; and
at least one blocking element held within the track within the enclosure, the at least one blocking element translatable along the track between a seated position and a displaced position, wherein the at least one blocking element plugs the air flow channel when in the seated position, and the air flow channel is at least partially unobstructed when the at least one blocking element is in the displaced position, wherein the at least one blocking element is configured to be moved from the seated position to the displaced position by positive air pressure on the interior side of the enclosure to permit outbound air flow through the air flow channel.

2. The pressure relief vent of claim 1, wherein the at least one blocking element is biased towards the seated position.

3. The pressure relief vent of claim 1, wherein the seated position is vertically lower than the displaced position, and the at least one blocking element is biased towards the seated position by the force of gravity.

4. The pressure relief vent of claim 1, wherein the at least one blocking element is free-floating within the track.

5. The pressure relief vent of claim 1, wherein the at least one blocking element is configured to maintain the seated position without moving to the displaced position in response to positive air pressure on the exterior side of the enclosure to restrict inbound air flow through the air flow channel.

6. The pressure relief vent of claim 1, wherein the at least one blocking element is cylindrical and has a longitudinal axis parallel to a plane of the interior side of the enclosure, wherein the at least one blocking element at least one of slides or rolls along the at least one guide member between the seated and displaced positions.

7. The pressure relief vent of claim 1, wherein the at least one blocking element is cylindrical and has a longitudinal axis parallel to a plane of the interior side of the enclosure, wherein a diameter of the cylinder is greater than a dimension of an aperture along the air flow channel to enable the cylinder to plug the air flow channel by obstructing the aperture when in the seated position.

8. The pressure relief vent of claim 1, wherein the enclosure extends along a vertical axis between top and bottom ends of the enclosure and extends along a lateral axis between first and second side edges of the enclosure, wherein the at least one blocking element includes multiple blocking elements arranged side by side in a vertical stack between the top and bottom ends, each of the blocking elements being elongated parallel to one another and parallel to the lateral axis of the enclosure.

9. The pressure relief vent of claim 1, wherein the at least one guide member includes fins having sloped support surfaces that engage the at least one blocking element, the fins being spaced apart along a lateral width of the enclosure, the air flow channel defined between the fins.

10. The pressure relief vent of claim 1, wherein the enclosure is defined by a housing and a cartridge that is coupled to the housing, the cartridge defining at least a portion of the exterior side of the enclosure, the at least one blocking element held within the cartridge.

11. The pressure relief vent of claim 1, wherein the enclosure is defined by a housing and a frame that is coupled to the housing, the frame defining at least a portion of the exterior side of the enclosure, the at least one blocking element sandwiched between the housing and the frame, wherein at least one of the housing and the frame includes the at least one guide member that engages the at least one blocking element.

12. A pressure relief vent comprising:
an enclosure having a vertical height from a top end of the enclosure to a bottom end of the enclosure and having a thickness from an interior side of the enclosure to an exterior side of the enclosure, the enclosure defining an air flow channel that extends through the thickness of the enclosure, wherein the enclosure includes at least one guide member defining a vertically-inclined track between the interior and exterior sides; and
at least one blocking element held by the enclosure and free-floating within the track, the at least one blocking element translatable along the track between a seated position and a displaced position that is vertically higher than the seated position, wherein the at least one blocking element plugs the air flow channel when in the seated position, and the air flow channel is at least partially unobstructed when the at least one blocking element is in the displaced position,
wherein the at least one blocking element is biased towards the seated position by the force of gravity and is configured to be lifted from the seated position to the displaced position by positive air pressure on the interior side of the enclosure to permit outbound air flow through the air flow channel.

13. The pressure relief vent of claim 12, wherein the enclosure includes a wall defining an aperture that represents a segment of the air flow channel, wherein the at least one blocking element is located between the wall and the exterior side of the enclosure along the air flow channel and the at least one blocking element in the seated position engages the wall to cover the aperture and plug the air flow channel.

14. The pressure relief vent of claim 12, wherein the at least one blocking element is cylindrical and has a longitudinal axis oriented perpendicular to the height of the enclosure and parallel to a plane of the interior side of the enclosure, wherein the at least one blocking element at least one of slides or rolls along the at least one guide member between the seated and displaced positions.

15. The pressure relief vent of claim 12, wherein the at least one blocking element is configured to maintain the seated position without moving to the displaced position in response to positive air pressure on the exterior side of the enclosure to restrict inbound air flow through the air flow channel.

16. The pressure relief vent of claim 12, wherein the at least one guide member includes fins having sloped support surfaces that engage the at least one blocking element, the fins being spaced apart along a lateral width of the enclosure, the air flow channel defined between the fins.

17. The pressure relief vent of claim 12, wherein the enclosure is defined by a housing and at least one of a cartridge or a frame that couples to the housing and defines at least a portion of the exterior side of the enclosure.

18. A pressure relief vent comprising:
an enclosure having a thickness extending along a depth axis from an interior side of the enclosure to an exterior side of the enclosure and having a width extending along a lateral axis from a first side edge of the enclosure to a second side edge of the enclosure, the enclosure defining an air flow channel that extends through the thickness of the enclosure, wherein the enclosure includes at least one guide member between the interior and exterior sides, the at least one guide member defining a track that is oriented transverse to the depth axis; and
at least one blocking element held within the track within the enclosure, the at least one blocking element being elongated parallel to the lateral axis of the enclosure, an outer surface of the at least one blocking element being at least one of slidable or rollable along the at least one guide member between a seated position and a displaced position, wherein the outer surface of the at least one blocking element plugs the air flow channel when in the seated position, and the air flow channel is at least partially unobstructed when the at least one blocking element is in the displaced position,
wherein the at least one blocking element is configured to be moved from the seated position to the displaced position by positive air pressure on the interior side of the enclosure to permit outbound air flow through the air flow channel.

19. The pressure relief vent of claim 18, wherein the at least one blocking element is cylindrical and the outer surface of the at least one blocking element has a circular cross-section.

20. The pressure relief vent of claim 18, wherein the seated position of the at least one blocking element within the track is vertically lower than the displaced position, and the at least one blocking element is biased towards the seated position by the force of gravity.
